(19) United States
(12) Patent Application Publication
(10) Pub. No.: US 2003/0028875 A1
(43) Pub. Date: Feb. 6, 2003

(54) Television access control system

(75) Inventor: Tony E. Piotrowski, Wayne, NJ (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/847,221

(22) Filed: May 2, 2001

(51) Int. Cl. H04N 5/445; H04N 7/173

(52) U.S. Cl. 725/38; 725/93

(57) ABSTRACT

An arrangement for the control of viewing of a video/television program in which a rating code and a position code are transmitted with the video/television signal. The codes are decoded and processed via a microcontroller. A viewer of the video signal is able to enter codes of permitted program ratings using a remote control unit. The rating codes are based upon the content of the video signal. The position codes relate to the display position of possibly objectionable content. Based upon a comparison of the received codes and the permitted program ratings portions of video signal are blanked and/or muted. The position codes allow for sub-portions of the image display to be blocked rather than the entire display.

### FIELD OF THE INVENTION

The invention relates to a system and method controlling the inhibition of video/television program display in dependence on the program content, in particular, the method and system allow for display-control of sub-portions of visual images as well as enchanted control of muting audio portions of the video/television program.

### BACKGROUND OF THE INVENTION

In the United States, a so called “V-chip” is used monitor codes transmitted with a television signal and disable the television receiver display when the codes indicate forbidden program material including scenes of violence, sex or other matter which might be considered objectionable by some audiences or unsuitable for children. Parents, for example, can formulate their decision on the basis of ratings that are assigned to movies and TV programs by an appointed board that views them before broadcast. Broadcasters may rate their program in four censorship categories. The values for each category are then transmitted simultaneously as part of the extended data services (EDS) of the Closed Captioning (CC) system. In particular, V-chip data is sent as a packet as part of the EDS provided on line 21 field 2 data. EDS are additional services that may be used/performed related to a TV program. The V-chip data is transmitted for as long as the program is on the air.

An advantage of using V-Chip is that the program blocking is independent of the channel where the program is being transmitted. As long as a data packet (sent during the Vertical Blanking Interval) containing rating information is received and the blocking criterion is met, the program will be blocked irrespective of the channel.

Using an access control mechanism, parent may set a predetermined threshold for each category. If at rating exceeds the pre-authorised value, the V-chip; suppresses the video and audio signals. As the reaction of the V-chip decoder is near instantaneous, the system can easily handle channel hopping. Moreover, the parent does not have to worry about missing content warnings in TV guides or at the start of programmes.

The Electronic Industries Association (EIA) defines the four censorship categories and the number of data bits required to transmit the code:

MPAA rating (equivalent to film classifications, e.g. 18, PG, etc.)—3 bits

violence content advisory level—2 bits (which allows for a scale of 0 to 3)

sexual content advisory level—2 bits

mature content advisory level—2 bits.

A CC decoder is used to provide subtitling on the display screen. Current CC decoders (such as the SAA5252 decoder sold by Philips Semiconductors) are capable of blanking out the TV picture when switched into full-text mode. They also have adequate display features to generate an on screen display (OSD) menu so that parents can program the censorship thresholds.

The concept of enabling a parent to control viewing of a television receiver using information transmitted by the broadcaster is not new and was proposed in W083/02208 published on Jun. 23, 1983. In that document it is proposed that a code is sent via the teletext signal transmitted with the television signal, the code being formed as a selected row number of a given teletext page. Thus the page number and row number is transmitted in the field blanking period on the occurrence of a possibly offensive event. At the receiver a teletext decoder is permanently set to look for the relevant page and identify the row number as and when transmitted. The particular row numbers indicated particular grading of sound and vision events.

These arrangements, however, typically require a parent, or other responsible person, to enter an appropriate code into the television receiver and/or video recorder that is applied to all programs. The program block is all or nothing. Thus, even if only a small portion of the program is objectionable, the entire program is blocked depending on the code classification program.

### SUMMARY OF THE INVENTION

One aspect of the invention is directed to a method of disabling sound and/or visual display of a video program. The method includes the steps of receiving a video signal including at least one rating code representing a program classification and at least one position code and comparing the rating code with a predetermined program code. Depending on the comparison result, the sound and/or a subsection of the visual display of the video program is disabled in accordance with the position code. The subsection of the visual display that is disabled may be less than the entirety of the visual display.

Another aspect of the invention is directed to an apparatus for controlling a video signal display system including a data capture module arranged to extract a rating code and a position code from a video signal. For example, the video signal may be a television program and the data capture module may form part of a closed captioning system within a television receiver. A comparitor receives the rating code and compares the rating code to a predetermined program code. A blanking circuit is used to mute an audio portion and/or a subsection of a visual display of the video signal in dependence on a comparison result from the comparitor and the position code. Once again, the subsection may be less than all of the visual display.

These and other features and advantages of the present invention will become more apparent from the accompanying drawings and the following detailed description.

### BRIEF DESCRIPTION OF THE DRAWINGS

FIG. 1 shows a television system.

FIG. 2 shows in block schematic of a television system in accordance with one embodiment of the present invention.

FIG. 3 illustrates data contained in a video signal in accordance with one embodiment of the invention.

FIG. 4 shows a block diagram of a display subdivided into segments.

FIG. 5 shows an example of blanking of a video program in accordance with one embodiment of the invention.

FIG. 6 illustrates on-screen display messages in accordance with an other embodiment of the invention.

### DETAILED DESCRIPTION OF THE INVENTION

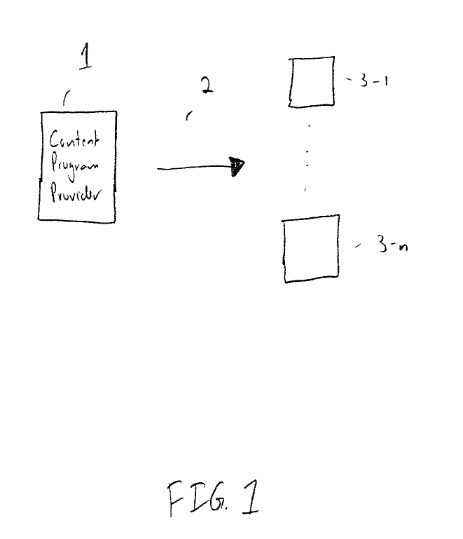

The system shown in FIG. 1 includes a television signal/program source 1, a television transmission medium 2, and a plurality of television receivers 3-1 to 3-n. The program source 1 may be conventional television broadcast equipment, e.g., terrestrial broadcast, satellite broadcast or a cable television source. The program source 1 includes a closed caption or teletext inserter and means for entering program classification codes into the EDS data.

The transmission medium 2 may take any convenient form for example it could be radio waves as broadcast by a terrestrial transmitter or a satellite transmitter or could be a cable network for a cable TV system. The television receivers 3-1 to 3-n are connected to the program source 1 via the transmission medium 2.

Another possible program source 1 is a video tape or disc on which a program is recorded for replay by a video tape recorder or a video disc player in which the case the transmission link 2 may be simply the tape recorder or disc player and a cable connecting the tape recorder or disc player to the television receiver.

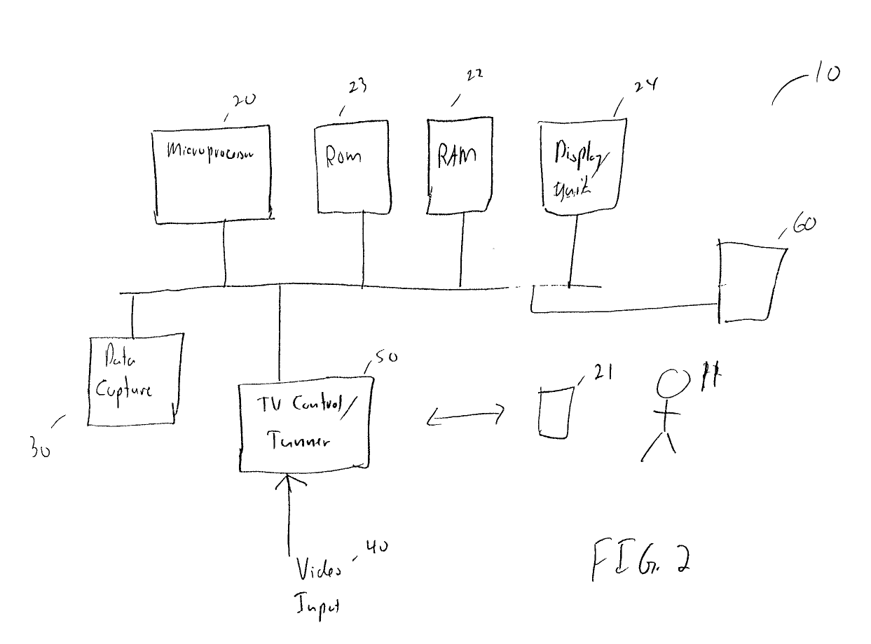

The television receiver 3-1 to 3-n should be equipped with extended data services (EDS) of the Closed Captioning (CC) capability or a similar functionality, e.g., teletext. FIG. 2 shows a block diagram of a television receiver 10 with CC and EDS capability. A data capture module 30 is configured to receive composite video signal (i.e., the TV program) from a TV control/tuner circuit 50. Blanking signals (i.e., the content advisory packet) are extracted from line 21 of the vertical blanking interval in the composite video signal. The content advisory packet is then processed via a microprocessor executing application software.

In particular, a control processor 20 controls in conventional fashion the operation of the television receiver 10. It may receive control instructions from a remote control unit 21 which a viewer 11 uses to select a particular channel for display and selects other functions such as CC display or on screen menu displays.

The control processor 20 receives from the data capture module 30 codes which are present in a received signal 40. The received signal 40 is provided from the program source 1. The codes representing the content of sexual matter, violent matter, distressing matter or mature language as associated with various real-time segments of the signal 40. The control processor 20 may store the codes within a non volatile memory 22. Input signals that have been entered by the viewer 11 using the remote control unit 21 may also be stored. These input signals set the levels of sexual, violent, distressing or mature language content which are acceptable for display.

The control processor 20 compares the received codes with the input signal and depending on the output of that comparison will produce a signal to the TV control/tuner 50 which in appropriate circumstances will cause a display unit 24 to blank an image display and/or mute the audio.

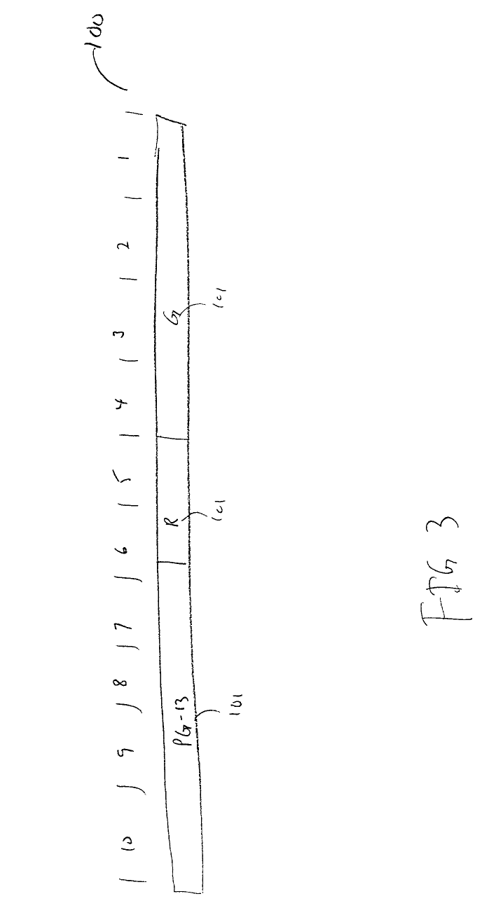

Illustratively, FIG. 3 show a program 100 which has been segmented into 10 segments. The number and real time lengths of each segment may vary depending on the content of the program 100. Each segment or portion thereof has an associated content rating code 101 (e.g., G, PG-13 and R). The content rating codes 101 are associated/inserted in the program 100 based upon the program content. For example, in segments 1-4, the content of the program 100 is rated G for general audiences. As discussed above, the content rating codes 101 are extracted by the data capture module 30 and processed accordingly.

In a preferred embodiment, the functions of the receiver 10 are implemented by computer readable code executed by the control processor 20. The code may be stored in a memory 23 or read/downloaded from a memory medium such as a CD-ROM or floppy disk. In other embodiments, hardware circuitry may be used in place of, or in combination with, software instructions to implement the invention. For example, the invention may be implemented on a digital television platform using a Trimedia processor for processing and a television monitor for display. The receiver 10 may also include a network connection 60 for interfacing to a data network, such as a variable-bandwidth network or the Internet or the public switched telephone network (PSTN).

In the current US content advisory system (see EIA/CEA-608-B), a content advisory packet includes two characters that contain information about the program's MPAA rating and the TV Parental Guidelines. These two systems are mutually exclusive, so if one is included the other shall not be. The following chart indicates the contents of the characters:

| Character | b6 | b5 | b4 | b3 | b2 | b1 | b0 |
|---|---|---|---|---|---|---|---|
| MPAA Rating | 1 | D | a1 | a0 | r2 | r1 | r0 |
| TV Parental Guidelines | 1 | (F) V | S | L | g2 | g1 | g0 |

For example, the three bits r0-r2 are used to encode the MPAA picture rating if used.

| r2 | r1 | r0 | Rating |
|---|---|---|---|
| 0 | 0 | 0 | N/A |
| 0 | 0 | 1 | ″G″ |
| 0 | 1 | 0 | ″ PG″ |
| 0 | 1 | 1 | ″PG-13″ |
| 1 | 0 | 0 | ″R″ |
| 1 | 0 | 1 | ″NC-17″ |
| 1 | 1 | 0 | ″X″ |
| 1 | 1 | 1 | Not Rated |

When a rating higher than the rating level selected (by the program viewer or parent) is received, blocking will take place. The entire screen will be blanked, audio will be muted and CC information will not be shown (even if it is active). Once an acceptable rating level is received, unblocking will take place. The screen will be unblanked, audio will be unmuted and CC information display will resume (if necessary). In some application, if “No content rating data received” after waiting a predetermined amount of time, e.g., 5 seconds, the transmission is unblocked if blocked previously.

One embodiment of the present invention allows for more control of what information is blocked. This is accomplish by sending additional information in the content advisory packet to identify display positions to be blocked. This type of content advisory packet (with display position information) would be sent when a rating change occurred within a program being displayed.

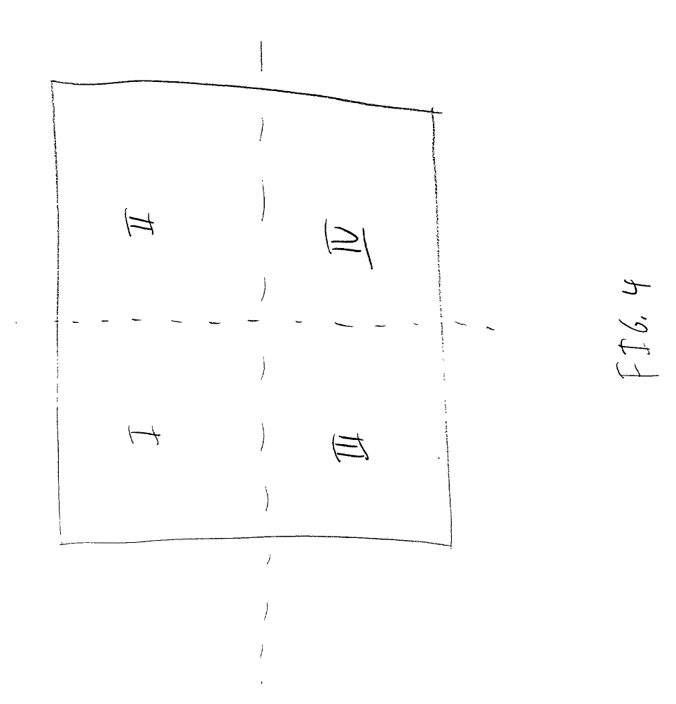

As shown in FIG. 4, a TV display screen has been divided into four sections. In this example, there are 16 different permutations or combinations of sections that may be blocked in this arrangement. These combinations can be represented by four bits of digital data. Greater granularity can be achieved by increasing the number of sections the display is subdivided into. The following table is an example of the position code functionality.

| Position | Blocked |
|---|---|
| Code | Sections |
| 00 h | none |
| 01 h | I |
| 02 h | I and II |
| . . . | |
| 0f h | I, II, III |
| | and IV |

The length of time the section is blocked can be indicated by using several bits within the position code. In the above table, the first four bits of the position code are not used. Four bits would allow up to 16 different time lengths to be used, e.g., from 1 to 16 seconds. Thus, if sections I and II were to be blocked for two seconds, a position code of 22h would be sent. It should be understood that the time divisions and lenghts can be modified as needed.

The position code can be inserted as an additional byte(s) of data in the content advisory packet. Alternatively, the information within the content advisory packet can alternate by first sending ratings code information and then display position information. The content advisory packet is sent as frequently as needed.

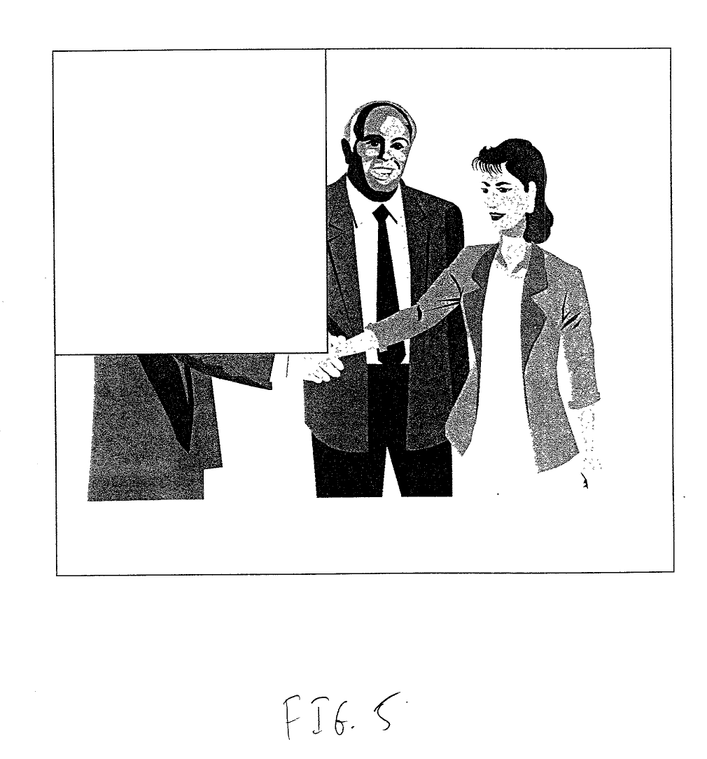

This allows viewers the ability to watch higher rated programs (e.g., R or PG-13) and selectively block only those portions of the program display which may be objectionable. For example, each segment of the program would have its own rating. Most of the program may be rated PG and only a few portions may have a higher rating such as R. In the case of the R rated portion, however, only sub-portions of the total image displayed may be objectionable, e.g., due to nudity. The nudity, for example, may only be contained in section I (of FIG. 4). Accordingly, an appropriate position code may be used to block only this objectionable sub-portion of the total image displayed, as shown in FIG. 5.

In another embodiment, an audio-only code can be used to block sub-portions of the audio track. For example, audio-only codes can be inserted to temporarily mute the audio track of the program. This can be used to block profanity (i.e., individual words) while allowing the entire image content of the program to be displayed. The placement/insertion of audio-only code can be synchronized to the audio track in a manner similar to primary synchronous caption service (CC1). In addition, the control processor 20 may receive an indication of the time from the EDS which is transmitted by the program provider.

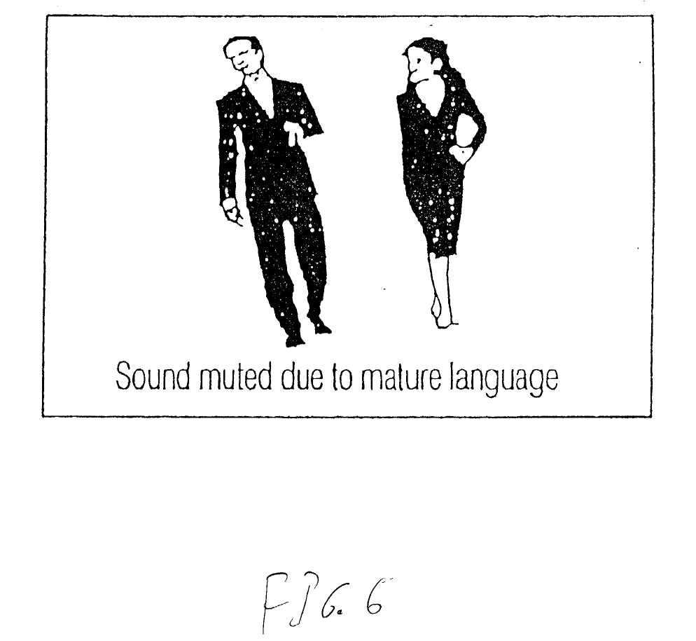

FIG. 6 shows an example of an on screen message which may be displayed when the blocking is in operation. The screen shows the picture displayed with a message superimposed upon it stating that the sound has been muted because of mature language. Consequently, since the viewer is informed that the sound is temporally muted he or she will not assume that there is a fault with the sound channel of the television receiver.

While the present invention has been described above in terms of specific embodiments, it is to be understood that the invention is not intended to be confined or limited to the embodiments disclosed herein. On the contrary, the present invention is intended to cover various structures and modifications thereof included within the spirit and scope of the appended claims.

What is claimed is:

1. A method of disabling sound and/or visual display of a video program, the method comprising the steps of:
receiving a video signal including at least one rating code representing a program classification and at least one position code;
comparing the rating code with a predetermined program code; and
disabling the sound and/or blocking a subsection of the visual display of the video program in dependence on a result of the comparison and in accordance with the position code, the subsection being less than all of the visual display.

2. The method according to claim 1, wherein the video signal is a television program.

3. The method according to claim 2, wherein position code identifies the subsection of the visual display to be blanked.

4. The method according to claim 2, wherein the rating code and the position code are received periodically and vary according to content contained within various segments of the video program.

5. The method according to claim 1, further comprising the step of entering and storing the predetermined program code.

6. The method according to claim 1, further comprising the step of extracting the rating code and the position code from the video signal using a data capture module.

7. An apparatus for controlling a video signal display system comprising:
a data capture module arranged to extract a rating code and a position code from a video signal;
a comparitor that receives the rating code and compares the rating code to a predetermined program code;
a blanking circuit arranged to mute an audio portion and/or block a subsection of a visual display of the video signal in dependence on a comparison result from the comparitor and the position code, the subsection being less than all of the visual display.

8. The apparatus according to claim 7, wherein the data capture module forms part of a closed captioning system.

9. The apparatus according to claim 8, wherein video signal is a television program and the rating code and the position code are extracted from line 21 of the vertical blanking internal.

10. The apparatus according to claim 7, wherein the data capture module forms part of a teletext system.,

11. A television receiver comprising:
means for receiving a television signal including at least one rating code representing a program classification and at least one position code inserted in a vertical blanking interval;
means for extracting the rating code and the position code;
means for comparing the rating code with a predetermined program code; and
means for disabling sound and/or blocking a subsection of a visual display of the television program in dependence on a result of a comparison result from said comparing means and in accordance with the position code, the subsection being less than all of the visual display.

12. The receiver according to claim 11, wherein position code identifies the subsection of the visual display to be blanked.

13. The receiver according to claim 11, wherein the rating code and the position code are received periodically and vary according to content contained within various segments of the television signal.

14. The receiver according to claim 11, further comprising means for entering and storing the predetermined program code.

15. The receiver according to claim 11, wherein said extracting means includes a data capture module and forms part of a closed captioning system.
